(19) United States
(12) Patent Application Publication
(10) Pub. No.: US 2008/0308640 A1
(43) Pub. Date: Dec. 18, 2008

(54) Contactless stand-alone assembly

(75) Inventor: Yung-Chieh Chien, Taipei (TW)

Correspondence Address: BACON & THOMAS, PLLC, 625 SLATERS LANE, FOURTH FLOOR, ALEXANDRIA, VA, 22314-1176, US

(73) Assignee: Taisys Technologies Co., Ltd., Taipei (TW)

(21) Appl. No.: 11/808,616

(22) Filed: Jun. 12, 2007

(51) Int. Cl. G06K 19/077

(52) U.S. Cl. 235/492

(57) ABSTRACT

The invention presents a contactless stand-alone assembly for insertion of an integrated circuit module, including an antenna for transmitting data between the integrated circuit module and a remote card reader; and a module holder for holding the integrated circuit module, electrically connected to the antenna for performing contactless transaction with the remote card reader.

### FIELD OF THE INVENTION

The present invention relates to a contactless stand-alone assembly, and more particularly, to a contactless stand-alone assembly for insertion of an integrated circuit module for performing contactless transaction with a remote card reader.

### BACKGROUND OF THE INVENTION

The term “smart card” is typically used to refer to various types of devices having an embedded integrated circuit for storing information. Smart card includes both contact and contactless cards (also referred to as proximity cards). Smart card communication devices are used to write information to the card and to read information from the card. Some smart card communication devices may only have the ability to read from or write to the smart card. Therefore, a smart card communication device may be a smart card reader, a smart card writer or both.

Typically, the smart card communication device is connected to a host computer that regulates transactions between the smart card and the smart card communication device. In some systems, however, the host computer may be part of the smart card communication device. Smart card systems may include any number of host computers and communication devices depending on the particular configuration and requirements of the system.

The smart card is a small, usually credit card shaped, device that contains at least a memory device for storing information and a transceiver to communicate with a smart card communication device. The smart card communication device communicates through the transceiver on the smart card to access the stored information. The smart card communication device may simply read the information, load the information into the memory device or modify existing data in the memory device. For example, if the owner of a smart card uses a smart card containing financial information to make a purchase, the smart card communication device can read the information including the owner's identity and the availability of funds. The smart card communication device can also deduct the purchase amount from the available funds if it has writing capabilities. Further, the communication device can store transaction data on the smart card including the time and location of the transaction in addition to the identity of the communication device.

Existing smart cards can be classified as either contact or contactless smart cards. It is not necessary for contactless smart cards (also referred to as proximity cards) to physically contact a smart card communication device to exchange data. Proximity cards typically employ modulated radio frequency (RF) field and impedance modulation techniques to transfer data between the proximity card and the proximity card communication device.

Smart cards have a variety of uses and can be utilized in any transaction that involves the exchange of data or information between individuals and an institution. For example, smart cards can be used to store information including medical records, financial information, vehicle maintenance information, pet information, and a variety of other information traditionally printed on paper or plastic or stored on cards having a magnetic stripe or an optical bar code. Smart card technology has been particularly useful in banking systems and other financial transaction systems. For example, smart card technology has been used effectively in mass-transit systems where the stored value on a smart card is decreased by an amount equal to the fare each time the passenger uses the card to gain access to or exits from the mass-transit system. As described above, other information may be stored or modified on the card such as the time and location of transaction.

The smart card technology is continually expanding in different directions while various manufacturers and industries influence the implementation of smart card systems.

Contactless smart cards typically have an antenna and a chip or contactless module located on a dielectric support made of plastic material (polyvinyl chloride (PVC), polyester (PET), polycarbonate (PC), and so on). The antenna is obtained by chemical copper or aluminum etching on the support or winding of conductive metal wire such as copper.

As shown in FIG. 1, U.S. Pat. No. 6,786,419 filed on Jun. 14, 2002 entitled “Contactless smart card with an antenna support and a chip support made of fibrous material” describes a contactless smart card including an antenna on an antenna support made of fibrous material, this antenna consisting of a turn and two contacts screen printed on the antenna support, a card body on each side of the antenna support, and a chip provided with contacts, connected to the antenna. This card also features a chip support made of fibrous material having two conductive strips, screen printed on the chip support, and to which the contacts of the chip are connected, the chip support being positioned on the antenna support so that the conductive strips come into contact with the contacts of the antenna and connect with the latter, and in such a way that the chip is positioned in a cavity, made for this purpose in the antenna support.

However, no matter whether the antenna support and the chip support are made of fibrous material or plastic material, to have the antenna incorporated into the same substrate as that of the chip would cause the production costs and manufacturing complexity to be relatively high. Therefore, in order to overcome these drawbacks, it is desired to have a contactless stand-alone assembly that could let the antenna and the chip separately existent, which would obviously lower the production costs and manufacturing complexity of a contactless smart card.

### SUMMARY OF THE INVENTION

Accordingly, the prior art is limited by the above problems. It is an object of the present invention to provide a contactless stand-alone assembly that could allow insertion of an integrated circuit chip for performing contactless transaction with a remote card reader.

In accordance with an aspect of the present invention, a contactless stand-alone assembly for insertion of an integrated circuit module, including an antenna for transmitting data between the integrated circuit module and a remote card reader; and a module holder for holding the integrated circuit module, electrically connected to the antenna for performing contactless transaction with the remote card reader.

Preferably, the assembly further includes a strap for hanging from an article.

Preferably, the article mentioned above includes a mobile phone, a personal digital assistant, a watch, or a key chain.

Preferably, the antenna transmits the data via over-the-air manner.

Preferably, the antenna is detachably connected to the module holder.

Preferably, the remote card reader includes an automatic teller machine (ATM) or a point of sales (POS) card reader.

Preferably, the antenna includes a magnetic loop antenna, a laminated induction coil antenna, or a planar antenna.

Preferably, the module holder includes a connecting interface for connecting the integrated circuit module and the antenna.

Preferably, further comprising a frequency modulator.

In accordance with another aspect of the present invention, a contactless stand-alone assembly, including an integrated circuit module; an antenna for transmitting data between the integrated circuit module and a remote card reader; and a module holder for holding the integrated circuit module, electrically connected to the antenna for performing contactless transaction with the remote card reader.

Preferably, the assembly further includes a strap for hanging from an article.

Preferably, the article mentioned above includes a mobile phone, a personal digital assistant, a watch, or a key chain.

Preferably, the antenna transmits the data via over-the-air manner.

Preferably, the antenna is detachably connected to the module holder.

Preferably, the remote card reader includes an automatic teller machine (ATM) or a point of sales (POS) card reader.

Preferably, the antenna includes a magnetic loop antenna, a laminated induction coil antenna, or a planar antenna.

Preferably, the module holder includes a connecting interface for connecting the integrated circuit module and the antenna.

Preferably, further comprising a frequency modulator.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a block diagram of a contactless stand-alone assembly according to the present invention; and

FIG. 2 is a schematic diagram of one embodiment of the present invention.

### DETAILED DESCRIPTION OF THE PREFERRED EMBODIMENT

The present invention discloses a contactless stand-alone assembly for insertion of an integrated circuit module for performing contactless transaction, and the objects and advantages of the present invention will become more readily apparent to those ordinarily skilled in the art after reviewing the following detailed description. The present invention needs not be limited to the following embodiment.

Typical contactless smart card consists of a chip module and an antenna, both encapsulated in a card body. The chip module is usually mounted on an antenna sheet (plastic sheet with etched, printed or embedded antenna structure thereon), which limits the independent use of either the chip module or the antenna. The usage and type of antenna of the contactless smart card are both determined before being manufactured, which makes every contactless smart card unable to have additional functionality and compatibility.

Physically, an antenna is an arrangement of conductors that generate a radiating electromagnetic field in response to an applied alternating voltage and the associated alternating electric current, or can be placed in an electromagnetic field so that the field will induce an alternating current in the antenna and a voltage between its terminals. Antennas may differ in length, shape, material, etc., depending on different uses or contactless smart card issuers.

Therefore, the object of the present invention is to provide an assembly including an antenna that can be widely used for insertion of an integrated circuit module for performing contactless transaction with a remote card reader. In this way, it may not be necessary for contactless smart card issuers to produce a contactless smart card with an antenna. The smart card issuers only need to produce a chip module. Thus, this may lower the production costs and manufacture complexity of the contactless smart card. Furthermore, due to the stand-alone form of the chip module, the chip module can be easily reprogrammed or modified for future additional needs.

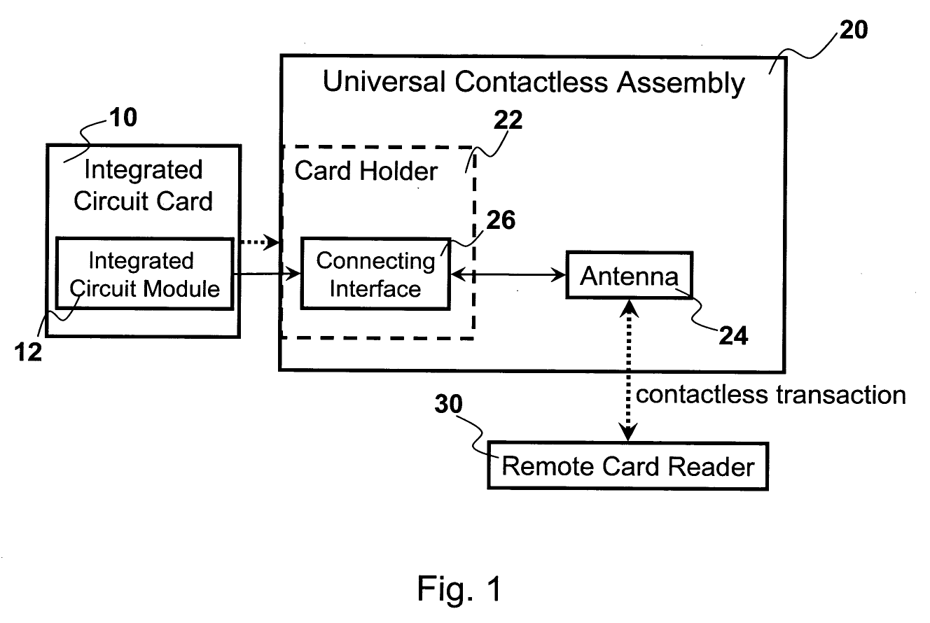

Please refer to FIG. 1. It is a block diagram of a contactless stand-alone assembly 20 according to the present invention. The contactless stand-alone assembly 20 includes an antenna 24 for transmitting data between the integrated circuit module 10 and a remote card reader 30 via over-the-air, and a module holder 22 for insertion of an integrated circuit module 10 having an integrated circuit chip 12 embedded therein. The remote card reader, for example, may be an automatic teller machine (ATM) or a point of sales (POS) card reader.

The module holder 22 has a connecting interface 26 electrically connecting the antenna 24 with the integrated circuit chip 12 of the integrated circuit module 10 while being inserted for sending data therebetween. The form and material of the antenna 24 are not limited. It can be a magnetic loop antenna, a laminated induction coil antenna, or a planar antenna. The connecting interface 26 of the module holder 22 provides two electrical contact ends (not shown) for connection of the antenna 24. Thus, even though antennas may have various different kinds, they can all be electrically connected to the module holder 22 by connecting the two electrical contact ends (not shown) with two ends of the antenna itself. This allows the antenna 24 to be detachably connected to the module holder 22. In other words, the antenna 24 can be changed according to different needs without changing the module holder 22. This may also lower the production costs of manufacturing of contactless smart cards.

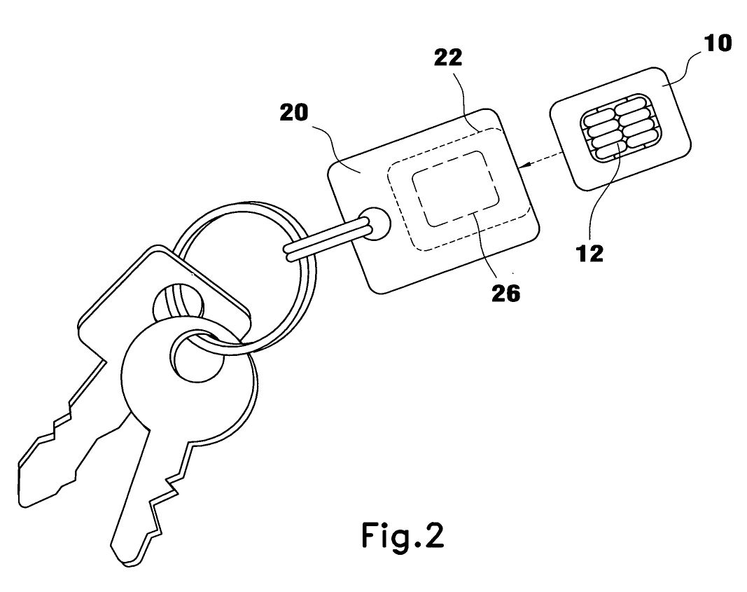

Please refer to FIG. 2. It is a schematic diagram of one embodiment of the present invention. It illustrates a contactless stand-alone assembly 20 designed as a key chain for convenience of a user. As mentioned above, the contactless stand-alone assembly 20 includes a module holder 22, and an antenna 24 (as shown in FIG. 1).

A user just needs to insert an integrated circuit module 10 stored with identification information and transaction related data. Then, once the integrated circuit module 10 is inserted into the module holder 22 of the contactless stand-alone assembly 20, a contact area (not shown) of the connecting interface 26 would directly contact the integrated circuit chip 12 embedded on the integrated circuit module 10. Accordingly, the antenna 24 that is electrically connected to the connecting interface 26 would also be electrically connected to the integrated circuit chip 12.

Therefore, once a remote card reader 30 (shown in FIG. 1) is within a certain distance, usually within 10 cm according to the length of the antenna, the contactless transaction will be executed and data will be transmitted via the antenna 24. The contactless transaction may be a transportation payment, credit card transaction, security access, and so on.

The contactless stand-alone assembly 20 inserted with the integrated circuit module 10 can operate without the need of any other electrical devices. Therefore, the contactless stand-alone assembly 20 further includes a strap for hanging from various kinds of articles, such as a mobile phone, a personal digital assistant, a watch, a key chain, etc. In other words, it could be designed as a part of a key chain as shown in FIG. 2, or even a carrying strap or hang tag of a mobile phone.

Contactless smart cards are now in widespread use due to the convenience thereof. However, the more common it is, the more cards people carry, which contrarily makes it inconvenient. The capability of traditional contactless cards is fixed as it is manufactured, whereas the design of separating the integrated circuit chip from the antenna makes it possible for the integrated circuit chip to be modified or incorporated with new functions.

Due to the detachability of the integrated circuit module 10, another advantage of the present invention is that the user can insert the integrated circuit module 10 into different universal contactless assemblies provided with different kinds of antennas according to his/her needs. For example, if “antenna ABC” is authorized by a credit card issuer “company ABC” and “antenna XYZ” is authorized by “company XYZ”, then the user just needs to insert the integrated circuit module 10 into a contactless stand-alone assembly 20 with “antenna ABC” while he wishes to pay by the credit card issued by “company ABC”, and insert the integrated circuit module 10 into a contactless stand-alone assembly 20 with “antenna XYZ” while he wishes to pay by the credit card issued by “company XYZ”. On the other hand, for “company ABC”, they would just need to provide a service for modifying an integrated circuit chip or to provide a contactless stand-alone assembly 20 with “antenna ABC”, which would be much cheaper than to produce a contactless smart card with an antenna embedded therein. As for “company XYZ”, they would just need to provide a service for modifying an integrated circuit chip or to provide a contactless stand-alone assembly 20 with “antenna XYZ”.

Furthermore, the contactless stand-alone assembly 20 can also include a frequency modulator (not shown) for adjusting the frequency of the contactless stand-alone assembly 20 to adapt to the frequency of the antenna 24 to be used. The frequency modulator may be a resistor or a capacitor.

While the invention has been described in terms of what is presently considered to be the most practical and preferred embodiment, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A contactless stand-alone assembly for insertion of an integrated circuit module, comprising:
an antenna for transmitting data between said integrated circuit module and a remote card reader; and
a module holder for holding said integrated circuit module, electrically connected to said antenna for performing contactless transaction with said remote card reader.

2. The contactless stand-alone assembly according to claim 1, wherein said assembly further comprises a strap for hanging from an article.

3. The contactless stand-alone assembly according to claim 2, wherein said article comprises a mobile phone, a personal digital assistant, a watch, or a key chain.

4. The contactless stand-alone assembly according to claim 1, wherein said antenna transmits said data via over-the-air manner.

5. The contactless stand-alone assembly according to claim 1, wherein said antenna is detachably connected to said module holder.

6. The contactless stand-alone assembly according to claim 1, wherein said remote card reader comprises an automatic teller machine (ATM) or a point of sales (POS) card reader.

7. The contactless stand-alone assembly according to claim 1, wherein said antenna comprises a magnetic loop antenna, a laminated induction coil antenna, or a planar antenna.

8. The contactless stand-alone assembly according to claim 1, wherein said module holder comprises a connecting interface for connecting said integrated circuit module and said antenna.

9. The contactless stand-alone assembly according to claim 1, further comprising a frequency modulator.

10. A contactless stand-alone assembly, comprising:
an integrated circuit module;
an antenna for transmitting data between said integrated circuit module and a remote card reader; and
a module holder for holding said integrated circuit module, electrically connected to said antenna for performing contactless transaction with said remote card reader.

11. The contactless stand-alone assembly according to claim 10, wherein said assembly further comprises a strap for hanging from an article.

12. The contactless stand-alone assembly according to claim 11, wherein said article comprises a mobile phone, a personal digital assistant, a watch, or a key chain.

13. The contactless stand-alone assembly according to claim 10, wherein said antenna transmits said data via over-the-air manner.

14. The contactless stand-alone assembly according to claim 10, wherein said antenna is detachably connected to said module holder.

15. The contactless stand-alone assembly according to claim 10, wherein said remote card reader comprises an automatic teller machine (ATM) or a point of sales (POS) card reader.

16. The contactless stand-alone assembly according to claim 10, wherein said antenna comprises a magnetic loop antenna, a laminated induction coil antenna, or a planar antenna.

17. The contactless stand-alone assembly according to claim 10, wherein said module holder comprises a connecting interface for connecting said integrated circuit module and said antenna.

18. The contactless stand-alone assembly according to claim 10, further comprising a frequency modulator.
